(19) United States
(12) Patent Application Publication
(10) Pub. No.: US 2015/0194653 A1
(43) Pub. Date: Jul. 9, 2015

(54) METHOD OF MAKING A RUBBER-CONTAINING POLYOLEFIN SEPARATOR

(71) Applicant: Amtek Research International LLC, Lebanon, OR (US)

(72) Inventors: Robert R. Waterhouse, Scio, OR (US); Chi Thuong-Le La, Happy Valley, OR (US); Andy Villeneuve, Lebanon, OR (US); Kirk Hanawalt, Albany, OR (US); Richard W. Pekala, Corvallis, OR (US)

(21) Appl. No.: 14/412,416

(22) PCT Filed: Jul. 3, 2013
(86) PCT No.: PCT/US2013/049365

§ 371 Date: Dec. 31, 2014

Related U.S. Application Data
(60) Provisional application No. 61/667,887, filed on Jul. 3, 2012.

(51) Int. Cl. H01M 2/16; B29C 47/10; H01M 2/14

(52) U.S. Cl. CPC H01M 2/166; H01M 2/145; B29C 47/1081; B29K 2023/0683

(57) ABSTRACT

A method of making a rubber-containing polyolefin separator entails preparing a pre-mixture (18) that includes polyolefin material (1), silica (2), and processing oil (5) and delivering the pre-mixture to a multi-zone extruder (12) having a sheet die (34). The pre-mixture becomes partly gelled as it advances in the extruder. Rubber powder (6) added at a medial zone (Z4) of the extruder combines with the pre-mixture advancing in the extruder to form a gelled rubber-containing extrudate as it exits the sheet die. The extrudate is processed by extracting a portion of the processing oil to form a separator sheet with dispersed rubber powder in the form of domains of larger average size. The larger rubber domains exhibit a smaller average ratio of surface area to volume and thereby results in slower release by diffusion of the beneficial substance from the rubber domains to the battery electrolyte.

### COPYRIGHT NOTICE

© 2013 Amtek Research International LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure relates to microporous silica-filled polyolefin separators and, in particular, a method of making a separator of such type that includes cured rubber powder exhibiting low or no porosity.

### BACKGROUND INFORMATION

International Publication No. WO 2011/059981 describes a silica-filled polyolefin battery separator having a material composition that includes a fraction of cured rubber powder exhibiting low or no porosity. The international application for patent published as the above-identified international publication is assigned to the assignee of this patent application. Separators for traction or deep-cycle lead-acid batteries, which have positive electrode grids containing antimony, often contain some rubber content to counter the effect that dissolved antimony can have on the negative electrodes of the battery. Rubber-containing separators for deep-cycle batteries have the advantageous effects of promoting long cycle life by controlling water loss during charge. During the charging of the lead-acid storage battery, the active material on the negative electrode is first reduced from lead sulfate to lead. As the available active material is converted to lead, the potential of the electrode is lowered. As the potential on the negative electrode drops, an increasing fraction of the charging current is involved in the evolution of hydrogen by reduction of the hydronium ions present in the adjacent electrolyte. Meanwhile, at the positive electrode, the charging operation is oxidizing the active material from lead sulfate to lead oxide, accompanied by a rise in the potential of the positive electrode. As the potential rises, an increasing fraction of the charging current is involved in the production of oxygen by oxidation of adjacent water molecules and the production of hydronium ions to replace those consumed at the negative electrode. The net effect of the evolution of hydrogen at the negative electrode and the evolution of oxygen at the positive electrode is the consumption of water from the acid electrolyte. This loss of water results in an increase in the concentration of the sulfuric acid, an increase in the resistance of the battery, and eventual failure. By reducing the rate of water loss from the battery, rubber-containing separators result in extending the service life of deep-cycle batteries. While the mechanism is not fully known, it is thought that the rubber contains a substance that diffuses into the sulfuric acid electrolyte to mitigate the effect antimony has on the negative electrodes.

International Publication No. WO 2011/059981 describes the use of a counter-rotating twin-screw extruder in the manufacture of a rubber-modified silica-filled separator. The described method of manufacture entails mixing in a batch mixer a standard silica-filled separator mixture and ground rubber and carrying out the same extrusion process as that used in the manufacture of a standard silica-filled separator.

### SUMMARY OF THE DISCLOSURE

The disclosed method of making a rubber-modified silica-filled separator entails forming and delivering to a multi-zone extruder a pre-mixture of polyolefin material, porous silica, and processing oil and thereafter adding cured rubber powder to the pre-mixture in partly gelled form at a medial zone of the extruder. Adding the cured rubber powder at a medial zone of the extruder subjects the cured rubber powder to less mixing action in the extruder and thereby facilitates less dispersion of the rubber powder. The extrudate produced is processed to form a microporous separator with substantially uniformly dispersed rubber powder in the form of rubber domains of larger average size. The larger domains possess a smaller average ratio of surface area to volume, resulting in a slower release by diffusion of the beneficial substance within the rubber to the sulfuric acid electrolyte of the battery.

Additional aspects and advantages will be apparent from the following detailed description of preferred embodiments, which proceeds with reference to the accompanying drawings.

### BRIEF DESCRIPTION OF THE DRAWINGS

FIG. 1 is a block diagram showing pre-mixing of compounding ingredients and the sequential addition of the pre-mixed ingredients and cured rubber powder in different zones of a twin-screw extruder in the production of the disclosed rubber-containing polyolefin separator.

FIGS. 2A, 2B, 2C, and 2D are SEM images, showing with increasing magnification, individual particles of the cured rubber powder added in the twin-screw extruder shown in FIG. 1.

FIGS. 3 and 4 are each a set of two optical micrographs showing, with increasing magnification, microporous separators produced from an extrudate formed as depicted in FIG. 1. Each set of images presents a side-by-side comparison showing differences in average sizes of rubber domains at the surfaces of separator sheets produced from extrudates in which cured rubber powder is added at zone Z0 and at zone Z4 of a twin-screw extruder.

FIGS. 5 and 6 are SEM images showing, with different magnifications, cured rubber domains located at the surfaces of separators of the type shown in, and formed with cured rubber powder introduced in the respective extruder zones Z0 and Z4 as described above with reference to FIGS. 3 and 4.

FIG. 7 is a SEM image showing in cross section a cured rubber domain located in the interior of a separator of the type shown in FIG. 5.

### DETAILED DESCRIPTION OF PREFERRED EMBODIMENTS

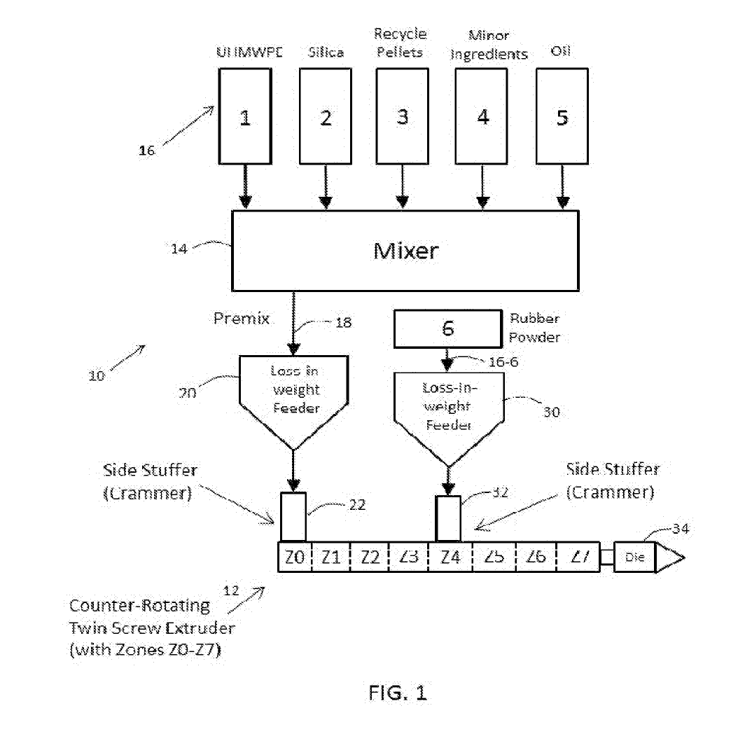

FIG. 1 is a block diagram of an extrusion system 10, in which an eight-zone counter-rotating twin-screw extruder 12 carries out a process of forming an extrudate in the production of a rubber-modified silica-filled polyolefin separator. Skilled persons will appreciate that the disclosed process may alternatively be performed with other extruder configurations, including with a co-rotating extruder. A mixer 14 receives different quantities of ingredients, which can include ultra-high molecular weight polyethylene (UHMWPE) 16-1, porous silica 16-2, recycle trim pellets 16-3, minor ingredients 16-4, and processing oil 16-5 to mix and thereby form a pre-mixture 18. A first loss-in-weight feeder 20 receives pre-mixture 18 and delivers it to a side-stuffer (crammer) 22 mounted horizontally to twin-screw extruder 12 at Zone 0 (Z0).

A second loss-in-weight feeder 30 receives a quantity of another ingredient, which is a cured rubber powder 16-6, preferably a non-porous cured rubber powder. Feeder 30 delivers cured rubber powder 16-6 to a side-stuffer (crammer) 32 mounted to twin-screw extruder 12 at Zone 4 (Z4). Rubber powder 16-6 added at a medial zone, e.g., zone Z4, combines with pre-mixture 18, which at zone Z4 has become partly gelled. Rubber powder 16-6 added at a medial zone has a short time of residence in twin-screw extruder 12 as the combined rubber powder 16-6 and pre-mixture 18 advances to Zone 7 (Z7) and through a sheet die 34 to form a gelled rubber-containing extrudate. The short time of combining rubber powder 16-6 with the partly gelled pre-mixture 18 gives rubber powder 16-6 adequate time to disperse but a greater propensity to retain rubber domains of larger average size. Alternatively, all or a portion of the cured rubber powder can be delivered to side-stuffer (crammer) 22. Alternatively, all or a portion of the processing oil can be delivered to side-stuffer (crammer) 22. Alternatively, all or a portion of the cured rubber powder can be delivered to mixer 14.

In a preferred embodiment, the quantities of the ingredients of pre-mixture 18 are 36.3 kg (80 lbs) of UHMWPE; 99.8 kg (220 lbs) of porous silica; 29.0 kg (64 lbs) of recycle trim pellets; 0.5 kg (1.1 lbs) of carbon black colorant, 0.5 kg (1.1 lbs) of anti-oxidant, and 26.3 kg (58 lbs) of lubricant; and 333.1 l (88 gal) of processing oil. The quantity of cured rubber powder is from about 1.0 wt. % to about 20 wt. % of the weight of the finished (i.e., post-processing oil extracted) separator. Ultrahigh molecular weight polyethylene (UHMWPE) having an intrinsic viscosity of at least 10 deciliters/gram is preferred to form the polyolefin web. A viscosity range of about 14-18 deciliters/gram is desirable for preferred embodiments of the separator. Although there is no preferred upper limit for the intrinsic viscosity, current commercially available UHMWPEs have an upper intrinsic viscosity limit of about 29 deciliters/gram. The UHMWPE matrix has sufficient porosity to allow liquid electrolyte to rapidly wick through it.

A preferred process oil used during extrusion of the separator web is one in which UHMWPE dissolves and is a nonevaporative liquid solvent at room temperature. While any extrusion process oil may be used, exemplary process oils include paraffinic oil, naphthenic oil, aromatic oil, or a mixture of two or more such oils. Examples of commercially available process oils include oils sold by Shell Oil Company (such as Gravex™ 41 and Catnex™ 945), oils sold by Chevron Oil Company (such as Chevron 500R), oils sold by Calumet Lubricants Co. (such as Hydrocal™ 800) and oils sold by Lyondell Oil Company (such as Tufflo™ 6056). A processed separator typically contains between about 12 wt. % to about 18 wt. % residual process oil.

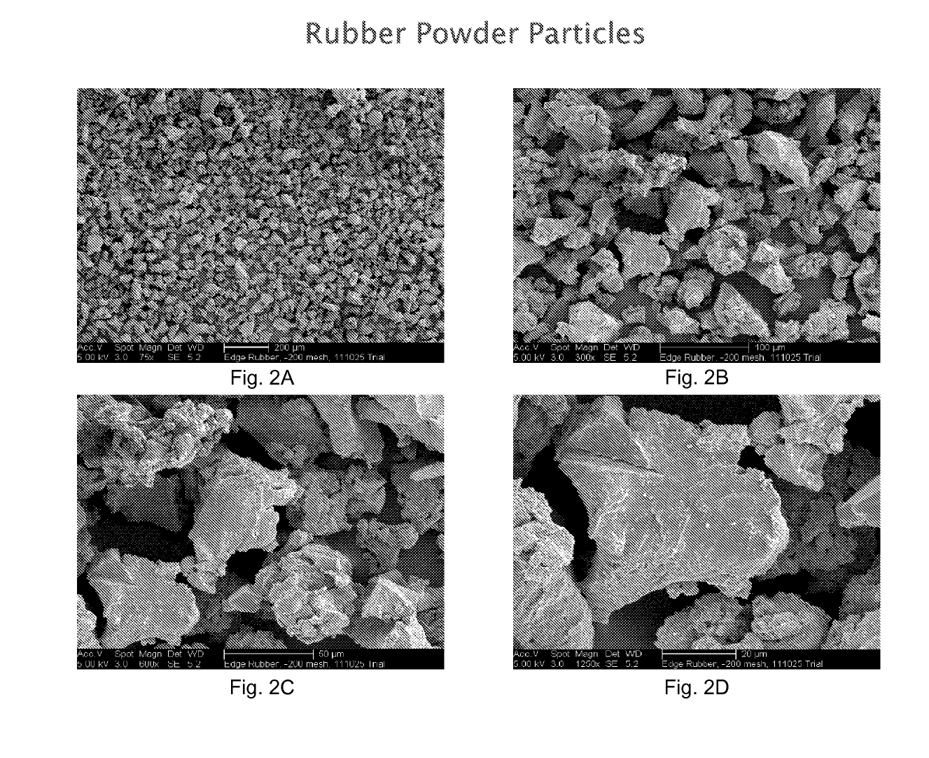

A preferred porous silica is Tixosil® 43, a conventional powder with thickening capabilities and manufactured by Rhodia. A preferred cured rubber is −200 mesh rubber powder, derived from passenger vehicle and truck tires and manufactured by Edge Rubber, Chambersburg, Pa. Skilled persons will appreciate that “cured rubber” is synonymous with “cross-linked rubber,” inasmuch as the rubber powder is derived from vehicle tire tread. Preferred cured rubber powder does not exceed 10% porosity. FIGS. 2A, 2B, 2C, and 2D show SEM images at, respectively, 1×, 2×, 4×, and 10× magnification the particles of −200 mesh rubber powder as received from Edge Rubber. The 1× dimension scale represents 200 μm.

Any solvent for extracting the process oil from the separator web may be used in the extraction process. Preferably, the solvent has a boiling point that makes it practical to separate the solvent from the plasticizer. Exemplary solvents include trichloroethylene, perchloroethylene, 1,2-dichloroethane, 1,1,1-trichloroethane, 1,1,2-trichloroethane, methylene chloride, chloroform, 1,1,2-trichloro-1,2,2-trifluoroethane, isopropyl alcohol, diethyl ether, acetone, hexane, heptane, and toluene.

Exemplary minor ingredients incorporated into the UHMWPE web include antioxidants, colorants, pigments, residual plasticizer or process oil, waxes, lubricants, other polymers, and processing aids.

The feed rate of pre-mixture 18 is 453.6 kg/hr (1,000 lbs/hr), and the crammer rotation speed at Z0 of side-stuffer (crammer) 22 is 57 rpm. The feed rate of rubber powder 16.6 is 4.54 kg/hr (10 lbs/hr), and the crammer rotation speed at Z4 of side-stuffer (crammer) 32 is 188 rpm. The melt pressure is 2760 psi (190 bar), and the screw rotation speed 75 rpm.

One suitable twin-screw extruder 12 is a Model E96L, manufactured by ENTEK Manufacturing LLC, Lebanon, Oreg. The ratio of length-to-diameter of each screw is set at 40, and the diameter of each screw is 96 mm.

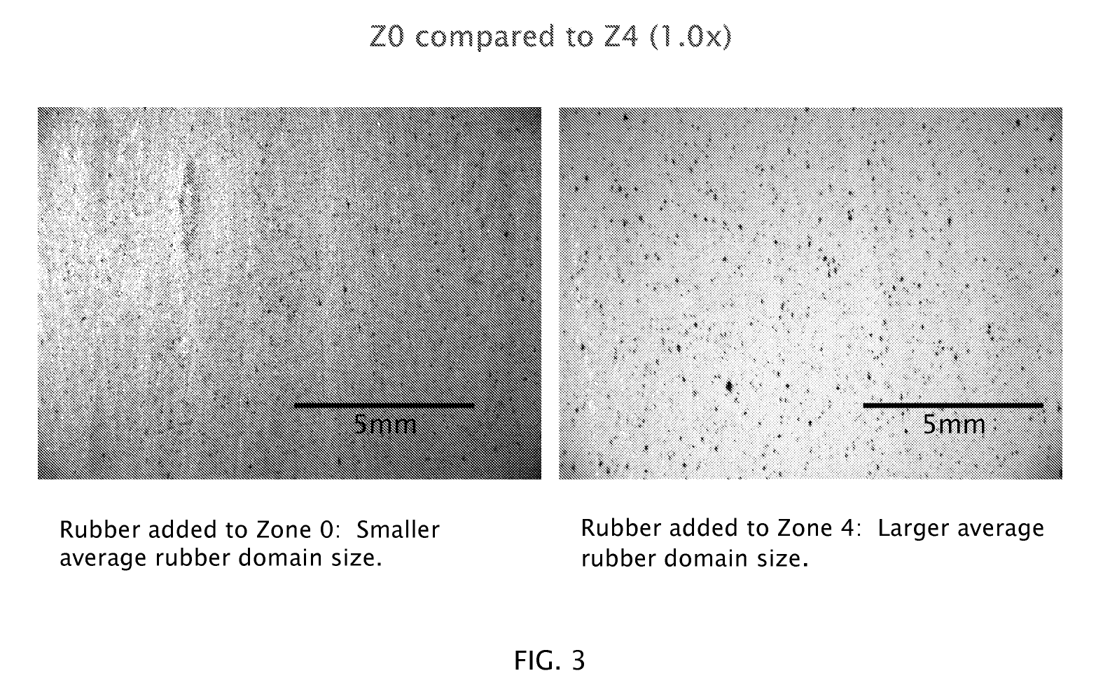

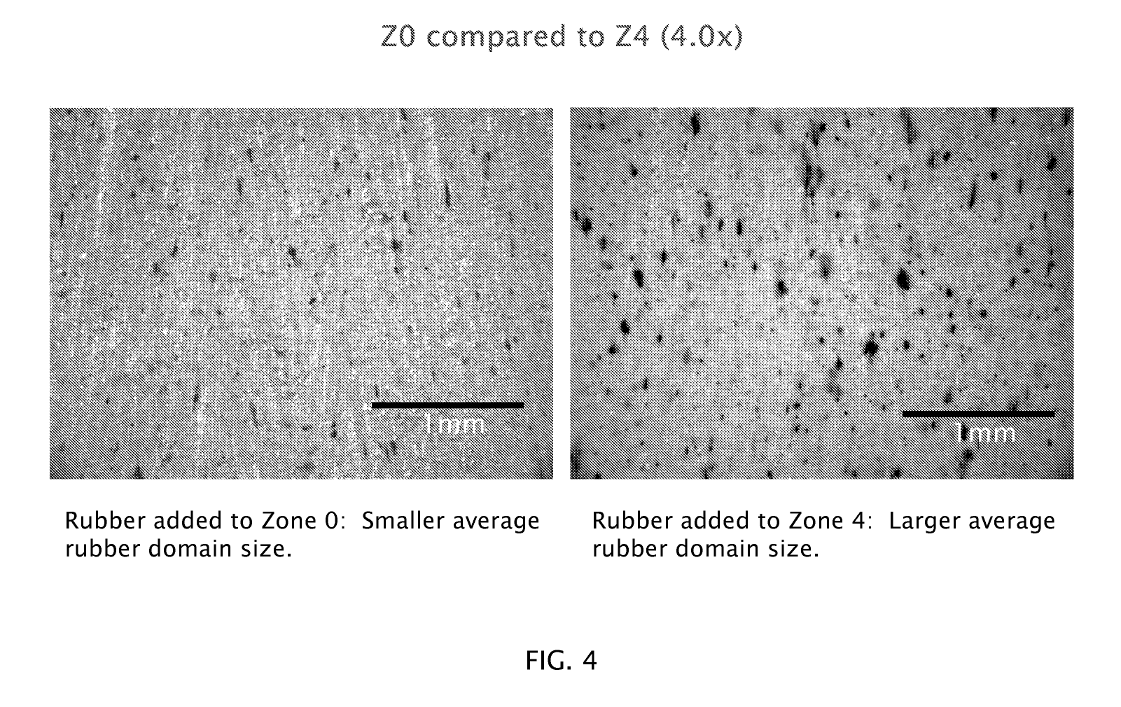

FIGS. 3 and 4 are optical micrographs showing with increasing magnification the differences in average sizes of rubber domains at the surfaces of separator sheets produced from extrudates formed by addition of cured rubber powder at zone Z0 and at zone Z4, respectively. A rubber domain is a formation of individually non-dispersed rubber powder, which is composed of a group of one or more rubber particles. All of the separator sheets were otherwise produced in the same manner, with the exception that no colorant was added to the formula to which cured rubber powder was added at zone Z4. FIGS. 3 and 4 show images at 1× and 4× magnification. Comparison of the left- and right-side images shows that rubber domains produced by adding cured rubber powder at zone Z4 (right-side image) are of larger average size than that of rubber domains produced by adding cured rubber powder at zone Z0 (left-side image). FIGS. 3 and 4 show, for finished separators, an average rubber domain size of about 31 μm resulting from delivery of cured rubber powder to zone Z0, as compared to an average rubber domain size of about 54 μm resulting from delivery of cured rubber to zone Z4. (The average domain size values are measured for the 40 largest domains in each image in FIG. 4 in the cross-machine direction only.) Table 1 below presents average rubber domain size data for the finished separators produced by delivery of rubber powder to zones Z0 and Z4. The size data entries under columns Z0 and Z4 represent, for each average rubber domain size category specified, the number of rubber domains present in the images shown in FIG. 4.

TABLE 1

| Size (mm) | Z0 | Z4 |
|---|---|---|
| 0.02 | 8 | 1 |
| 0.04 | 25 | 9 |
| 0.06 | 6 | 17 |
| 0.08 | 1 | 8 |
| 0.1 | 0 | 3 |
| 0.12 | 0 | 2 |

The delivery of rubber powder to zone Z4 instead of to zone Z0 corresponds, therefore, to as great as about a 3.0-fold increase in average surface area and as great as about a 5.3-fold increase in average volume of the rubber domains of the finished separator. The larger domains having less surface area in proportion to the volume of the domains results in a slower release of beneficial substance from the rubber domain to the battery electrolyte. Rubber domain size distribution appears to be uniform for both types of separator sheets shown.

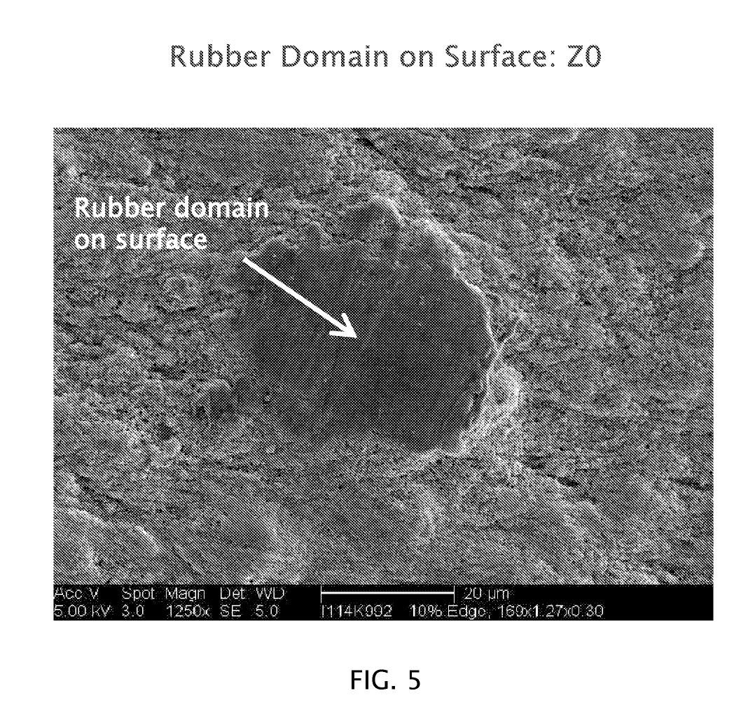

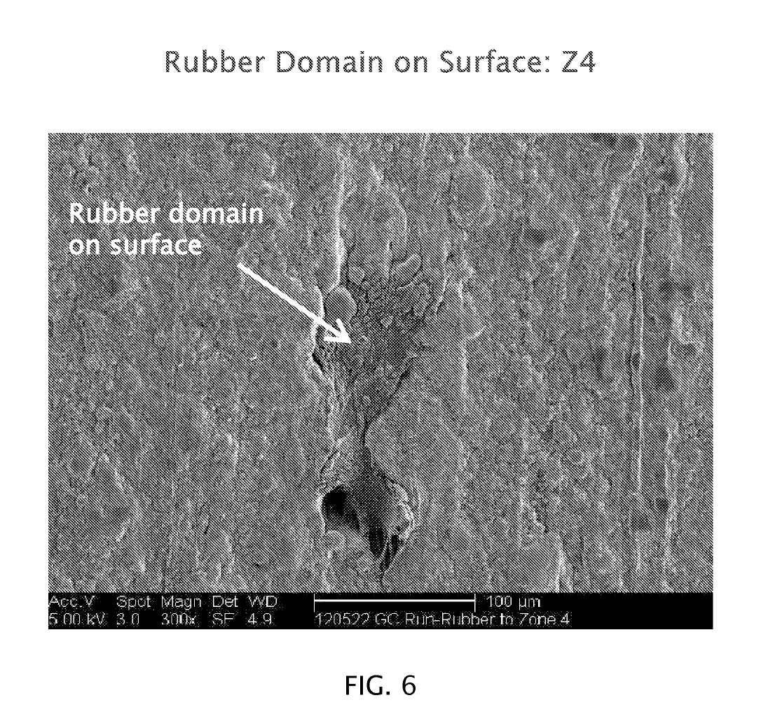

FIG. 5 shows with 1250× magnification a SEM image of a rubber domain located at the surface of the separator sheet produced from the extrudate formed with addition of cured rubber powder at zone Z0. FIG. 6 shows with 300× magnification a SEM image of a rubber domain located at the surface of the separator sheet produced from the extrudate formed with addition of cured rubber powder at zone Z4. Comparison of FIGS. 5 and 6 shows that the rubber domain shown in FIG. 5 is smaller than the rubber domain shown in FIG. 6, as demonstrated by the optical micrographs of FIGS. 3 and 4. The larger domain will have a slower release, by diffusion, of beneficial substance to the battery electrolyte.

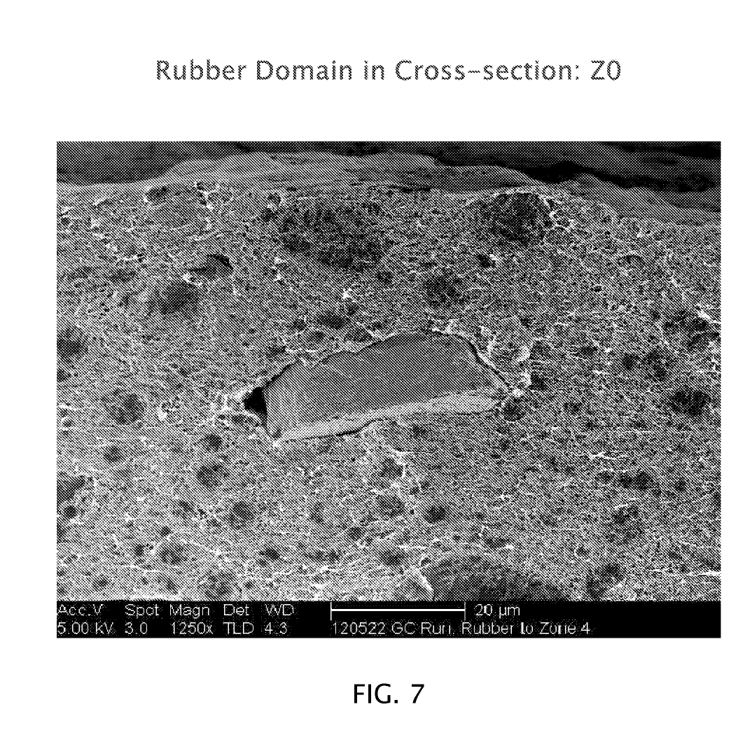

FIG. 7 shows with a cross-sectional view at 1250× magnification a SEM image of a rubber domain located in the interior of the separator sheet of FIG. 5. FIG. 7 indicates that the rubber domain located in the interior is of the same average size as that of the rubber domain located at the surface shown in FIG. 5.

It will be obvious to those having skill in the art that many changes may be made to the details of the above-described embodiments without departing from the underlying principles of the invention. The scope of the present invention should, therefore, be determined only by the following claims.

1. A method of making a rubber-containing polyolefin separator, comprising:
preparing a pre-mixture that includes polyolefin material, silica, and processing oil;
delivering the pre-mixture to a multi-zone extruder having a sheet die, the pre-mixture becoming partly gelled as the pre-mixture advances in the extruder;
adding rubber powder at a medial zone of the extruder to combine with the pre-mixture advancing in the extruder, the combined rubber powder and pre-mixture in the form of a gelled rubber-containing extrudate as it exits the sheet die; and
extracting a portion of the processing oil from the extrudate to form a separator sheet with dispersed rubber powder.

2. The method of claim 1, in which the silica is a porous silica of a fumed or precipitated type.

3. The method of claim 2, in which the rubber powder is a non-porous cured rubber powder.

4. The method of claim 1, in which no processing oil is added to the pre-mixture after it is delivered to the extruder.

5. The method of claim 1, in which the cured rubber powder does not exceed 10% porosity.

6. The method of claim 1, in which the cured rubber powder contains carbon black colorant.

7. The method of claim 1, in which the microporous silica-filled polyethylene separator contains a quantity of cured rubber powder of between about 1 wt. % and about 20 wt. % of the weight of the separator.
